(19) United States
(12) Patent Application Publication
(10) Pub. No.: US 2017/0022055 A1
(43) Pub. Date: Jan. 26, 2017

(54) METHOD AND APPARATUS FOR GENERATING AND FOR FUSING ULTRA-DENSE HYDROGEN

(71) Applicant: Airbus DS GmbH, Taufkirchen (DE)

(72) Inventor: Bernhard Kotzias, Bremen (DE)

(21) Appl. No.: 15/070,175

(22) Filed: Mar. 15, 2016

(30) Foreign Application Priority Data
Mar. 16, 2015 (DE) 102015103843.9
Sep. 3, 2015 (DE) 102015114744.0

(51) Int. Cl. C01B 3/00; B01J 21/06; B01J 8/02

(52) U.S. Cl. CPC C01B 3/0031; B01J 8/0278; B01J 8/0285; B01J 21/063; B01J 2208/02

(57) ABSTRACT

A method for generating and for fusing ultra-dense hydrogen in which molecular hydrogen is fed into at least one cavity and catalyzed, where the splitting and subsequent condensation of the molecular hydrogen is initiated on a catalyst of the cavity to form an ultra-dense hydrogen. The ultra-dense hydrogen is exposed to pressure or electromagnetic radiation to initiate fusion of the ultra-dense hydrogen in the at least one cavity and the reaction heat is led out from the at least one cavity. The pressure as mechanical resonance or the electromagnetic radiation as electromagnetic resonance amplifies the field and therefore the effect. Also, an apparatus for carrying out the method is disclosed.

### CROSS-REFERENCES TO RELATED APPLICATIONS

This application claims the benefit of the German patent application No. 102015114744.0 filed on Sep. 3, 2015 and of the German patent application No. 102015103843.90 filed on Mar. 16, 2015, the entire disclosures of which are incorporated herein by way of reference.

### BACKGROUND OF THE INVENTION

The invention relates to a method for generating and for fusing ultra-dense hydrogen as well as to an apparatus for carrying out the method.

In many areas, alternative energy sources are being sought which should, in particular, obviate the problems of energy sources based on nuclear reactions or fossil fuels. Here, mention is usually made of fusion processes which should have the potential to be durable, environmentally friendly and reliable.

In addition to hot fusion, various fusion processes in the field of cold fusion have already been described. In this case these frequently lack demonstrable functionality and efficiency. A development in the field of cold fusion towards the use of condensed matter is increasingly indicated.

For example, EP2680271A1 thus discloses a method and an apparatus for generating energy by nuclear fusion. In this case, gaseous hydrogen is catalytically condensed to ultra-dense hydrogen and collected on a carrier. The carrier is then brought into a radiation chamber in which the ultra-dense hydrogen can undergo fusion. Difficulties arise here, in particular, from the fact that the carrier must be transported under constant boundary conditions such as, for example, vacuum, so that the hydrogen cannot volatilize from its condensed state. The technical implementation of the method on an industrially usable apparatus can thus be very cumbersome.

In addition to EP2680271A1, mention can also be made of EP1551032A1. This describes a method for generating heat based on hydrogen condensates. In particular, hydrogen gas can be condensed on nanoparticles. For this purpose, the hydrogen gas must be exposed to high pressure. Due to ultrasound waves the condensed hydrogen atoms can fuse with one another and thus generate heat. Problematical here is the use of nanoparticles since, as a result of their reactivity, the effects on the environment have hitherto only been little clarified.

Further known from WO2009/125444A1 is a method and an apparatus for carrying out exothermic reactions between nickel and hydrogen. Hydrogen gas is brought under pressure into a tube filled with nickel powder. Under the action of heat, the system can be brought to fusion. In particular, the re-use or removal of nickel as a poisonous heavy metal appears problematical in this patent specification.

For technical applications under mechanically and thermally loaded environmental conditions, it has been found that metallic or ceramic foams specifically for the material of a fusion reactor are subjected to appreciable requirements with regard to the temperature resistance. If a stability above a temperature of 2000oC is to be achieved, only materials such as, for example, zirconium oxide, silicon carbide, nitride ceramic, carbon structures or the like remain. These are either not sufficiently temperature-resistant under an oxygen atmosphere or are very brittle and therefore mechanically unstable. Zirconium oxide ceramic, for example, is also not very stable in its pure form and is particularly affected by decomposition during use. Furthermore, it is also not suitable to “survive” for long in a mechanically severely loaded environment with many vibrations. Even transport has considerable risks with regard to the mechanical stability of the material.

Furthermore, a controlled state must be present. No melting of the carrier material must occur. The catalyst must not experience any change in structure and undergo effects of heat from the fusion or it must revert to its old structure after the melting process. Thus, a temperature range for a practicable fusion process can be limited.

Furthermore, the process control of a fusion process constitutes a problem of reaction delays. If the process takes place too slowly or too weakly, this is unfavorable for the efficiency. A certain reactivity is therefore required so that the process starts sufficiently rapidly when energy is required.

In addition, radioactive reaction channels can occur or neutrons can appear. These should be minimized in order to implement a practical application of the system. Finally, the generated energy should end as heat and less as radiation. A model of the reaction channels is therefore essential.

### SUMMARY OF THE INVENTION

It is an object of the invention to provide a method which eliminates the disadvantages and enables an environmentally friendly and efficient generation and fusing of ultra-dense hydrogen. Environmentally friendly means, in particular, avoiding the formation of radioactive isotopes and using toxic chemical substances. Furthermore, it is an object of the invention to provide an apparatus for carrying out the method according to the invention.

In a method for generating and for fusing ultra-dense hydrogen, molecular hydrogen at low pressure is fed into at least one cavity and catalyzed. According to the invention, in the introduced molecular hydrogen, condensation is initiated on a catalyst of the cavity to form an ultra-dense hydrogen. The ultra-dense hydrogen can be ignited, according to the invention, so that the ultra-dense hydrogen fuses in the at least one cavity. The thermal energy produced by the fusion process is then led out from the at least one cavity.

In this case, after previous evacuation at negative pressure, the molecular hydrogen can also be fed into the at least one cavity. Preferably, in addition to the catalyst, the material and the wall surface structure of the cavity also promote the condensation of the molecular hydrogen to form ultra-dense hydrogen. The material of the cavity is hereinafter also designated as carrier material. This carrier material can be mixed with a catalyst or coated with a catalyst. During the catalytic condensation, the molecular hydrogen is preferably split into atomic hydrogen. Hydrogen is understood here as all hydrogen isotopes as well as atoms electronically similar to hydrogen, such as potassium, sodium or the like. In addition, the split hydrogen molecules form an ultra-dense form of matter under special system parameters.

Since the condensed ultra-dense hydrogen has a high density and the individual hydrogen atoms lie close to one another, it is possible to initiate fusion by different methods and, in particular, with little energy.

The resulting reaction heat from the fusion is led out from the at least one cavity and can be used for various purposes. Preferably the reaction heat is either used for further initiations of fusion processes or made useable. For example, the heat can be used to generate mechanical and/or electrical energy. Other possible applications of the reaction heat can be found, for example, in water processing or in chemical conversion processes such as, for example, electrolysis.

In an advantageous exemplary embodiment of the method according to the invention, the molecular hydrogen is bound to the ultra-dense hydrogen after the condensing. The ultra-dense hydrogen can preferably be embedded both in the catalyst and in the carrier material of the at least one cavity. The ultra-dense hydrogen is stable and present in various spin sates. In this case, the hydrogen nuclei have a quantum-mechanical basic state which is fanned out in a spin-dependent fine structure and is characterized by the short distance of the hydrogen nuclei (protons) from one another. The distances can be less than 2.5 pm and even less than 0.6 pm. Thus, the hydrogen nuclei can be brought to fusion even without a fairly large energy supply. In some cases, the structures of the condensed hydrogen nuclei are present as superconducting and superfluid condensate with larger distances. The relationships of the various structures to one another are temperature-dependent. The superconducting and superfluid state has a transition temperature in the normal-conducting and therefore classical state of above 300oC or even 400oC—even lower with other materials. As a result of the embedding of the ultra-dense hydrogen, this can be used at an arbitrary time subsequently in the same cavity so that charging processes are possible for subsequent uses of the thermal energy.

According to a further exemplary embodiment of the method according to the invention, the fusion can be initiated electrically, electromagnetically or mechanically. Thus, a plurality of possible technical implementations is available to carry out the method. For example, the fusion can be initiated by laser radiation, electric plasma or piezo-elements or pressure.

In a further preferred exemplary embodiment of the method according to the invention, the reaction heat guided out from the at least one cavity is used for further initiation of fusion. As a result, a low local initiation energy is already sufficient to commence fusion in a plurality of cavities.

According to a preferred exemplary embodiment, the reaction heat guided out from the at least one cavity is converted into mechanical, electrical or chemical energy. As a result, the reaction heat can be converted into current, mechanical work or into chemical work such as, for example, electrolysis.

An apparatus for carrying out the method according to the invention for generating and for fusing ultra-dense hydrogen comprises at least one cavity for receiving molecular hydrogen and a catalyst for catalyzing the molecular hydrogen and an initiating source for initiating a fusion. According to the invention, the at least one cavity is at least one pore or vacancy of a metal or ceramic foam which is surrounded at its surfaces by the catalyst, at least in certain areas, and has an at least partial permeability for electromagnetic waves. As soon as the ultra-dense hydrogen condenses and has the superconducting phase, the walls then become electrically superconducting. A resonator having a high Q factor is formed. A mirror system with semi-transmitting walls, similar to a Fabry Perot cavity is formed.

In this case, the material arrangement can comprise a common carrier material which is mechanically and thermally stable up to above 2000oC and preferably is not toxic and also has no nanostructures so that manufacture is not made difficult.

This can be implemented, for example, by open-pore microporous oxide materials. The carrier material can, for example, be produced by sintering. It need not necessarily be active per se and thus condense ultra-dense hydrogen. The property for forming ultra-dense hydrogen can be introduced subsequently, for example, by catalysts. The catalyst can, for example, introduce positively charged vacancies into the sintered structure of the carrier material or be applied as coating to the carrier material. Consequently, the carrier material can be activated and stabilized at the same time, where the capacity to store condensed hydrogen remains unaffected by this.

The active carrier material here forms the ultra-dense hydrogen in two steps. Firstly, molecular hydrogen is split into atoms and then bound into the material lattice and the cavities and vacancies of the carrier material and between carrier material and catalyst and between catalyst and catalyst, with the result that the hydrogen atoms condense to ultra-dense hydrogen.

An example for an oxide carrier material is zirconium dioxide which must be mechanically stabilized, in particular, in a microporous form. The stabilization of zirconium dioxide can, for example, be accomplished by introducing alkaline earth metals or yttrium or other atoms or molecules having one or two free valence electrons.

As a result, the apparatus can be implemented technically particularly simply by producing a metal foam or a ceramic foam and then applying a corresponding catalyst. The apparatus can furthermore be connected integrally to further apparatuses such as, for example, for generating mechanical or electrical energy since metal can also be foamed in certain areas. Preferably the metal foam or the ceramic foam is designed to be open-pored so that molecular hydrogen can penetrate effectively. The foam structure of the metal foam or the ceramic foam increases the specific surface of the apparatus and therefore maximizes the volume available to the condensate of ultra-dense hydrogen.

In a preferred exemplary embodiment of the apparatus according to the invention, the catalyst has the form of a catalyst coating. As a result, the catalyst can be applied particularly simply to the metal foam or the ceramic foam. For example, this can be implemented by dipping into a solution, galvanically or by vapor deposition. Furthermore, a plasma coating or an introduction by means of a suspension solution is possible. The metal foam or the ceramic foam serves as carrier material for the catalyst coating. The catalyst coating serves as condensation accelerator. It therefore ensures that the matter can condense substantially more rapidly to an ultra-dense condensate than in an uncoated material which brings with it the capacity to condense ultra-dense hydrogen.

In a further exemplary embodiment, the catalyst is mixed with a 1-20 mass percent fraction of another metal which has no catalytic capacity to form ultra-dense hydrogen such as, e.g., copper. Thus, a hydride formation at higher pressure is avoided below 1 bar and the process parameters are simplified, negative pressures below 1 thousandth of a bar are easier to produce than negative pressures below less than one thousandth of a millibar.

According to an exemplary embodiment of the apparatus according to the invention, the catalyst coating has a granular and regular structure. Preferably it is a titanium oxide. Thus, a plurality of vacancies and cavities are formed on the surface. Furthermore, the formation of electronic surface structures (plasmons) is promoted and their coupling to the electromagnetic field in the cavity is improved. The catalyst can be introduced into the ceramic foam formed during sintering of the carrier material. This has a stabilizing effect on the ceramic so that increased mechanical forces can be absorbed. This can have a positive effect on the capacity for storage of ultra-dense hydrogen. The Casimir and capillary forces thus present have a positive effect on the condensation of the hydrogen. The specific surface can hereby be increased in addition to the foam structure.

The size of the cavities lies in the range of 1-40 μm diameter and therefore in the range of the maximum of the Planck radiation length if the fusion has delivered energy and heated the carrier material to a temperature of 400-2000 degrees C. The fusion process is thereby intensified.

The fusion process is further improved by the electromagnetic resonance capacity of the cells provided with superconducting ultra-dense hydrogen. Higher near and superposition forms of standing electromagnetic waves can in this case promote both the formation of ultra-dense hydrogen and also the fusion process.

A further exemplary embodiment of the apparatus according to the invention enables the molecular hydrogen to be split into atomic hydrogen on the catalyst coating and thereby condensed to form ultra-dense hydrogen. The condensed form is embedded in the material structure of the catalyst both of the metal foam or alternatively of the ceramic foam. As a result, condensation energy is released in advance.

According to a further preferred exemplary embodiment of the apparatus according to the invention, the ultra-dense hydrogen can be bound in the catalyst coating. As a result of this measure, the catalyst coating will not only fulfil the catalytic effect but will also receive and bind the condensed ultra-dense hydrogen. Preferably the ultra-dense hydrogen can also be embedded in the metal foam or ceramic foam. Not every material lattice can be “charged” with large quantities of hydrogen. In this case, in particular, cubic centered lattices having one or more oxygen atoms can be preferred. The oxygen can thus migrate from the lattice and create space for the ultra-dense hydrogen. The materials of the apparatus preferably comprise “alpha” lattice structures (cubic or otherwise space-centered).

In a further exemplary embodiment of the apparatus according to the invention, the catalyst coating comprises a titanium oxide. This material is already produced industrially in large quantities as powder and is therefore readily available.

According to an exemplary embodiment of the apparatus according to the invention, the surface of the at least one cavity can be coated by the condensed ultra-dense hydrogen. As a result, the cavity walls are mirror-coated with superconducting condensate of ultra-dense hydrogen in order to achieve a high Q factor for electromagnetic cavity resonances. Thus, an almost undamped electromagnetic resonance state is formed between the cavity and the ultra-dense hydrogen located therein. Reversible thermodynamic processes are obtained which positively influence the course of a fusion.

In an exemplary embodiment of the apparatus according to the invention, further metals are added to the catalyst to form ultra-dense hydrogen at high pressures. The pressure here relates to an effective operating pressure of less than 0.1 bar. By adding metals, a hydride formation is at least restricted. This is a parasitic process as a result of the catalytic effect of the apparatus.

### BRIEF DESCRIPTION OF THE DRAWINGS

In the following a preferred exemplary embodiment of the invention is explained in detail with reference to highly simplified schematic diagrams. In the figures:

FIG. 1 shows a section through an exemplary embodiment of the apparatus according to the invention,

FIG. 2 shows an enlarged view of section A from FIG. 1,

FIG. 3 shows an enlarged view of section B from FIG. 2,

FIG. 4 shows a schematic view of a charging process according to the method according to the invention, and

FIG. 5 shows a schematic view of a fusion process according to the method according to the invention.

In the drawings the same constructive elements each have the same reference numbers.

### DETAILED DESCRIPTION OF THE PREFERRED EMBODIMENTS

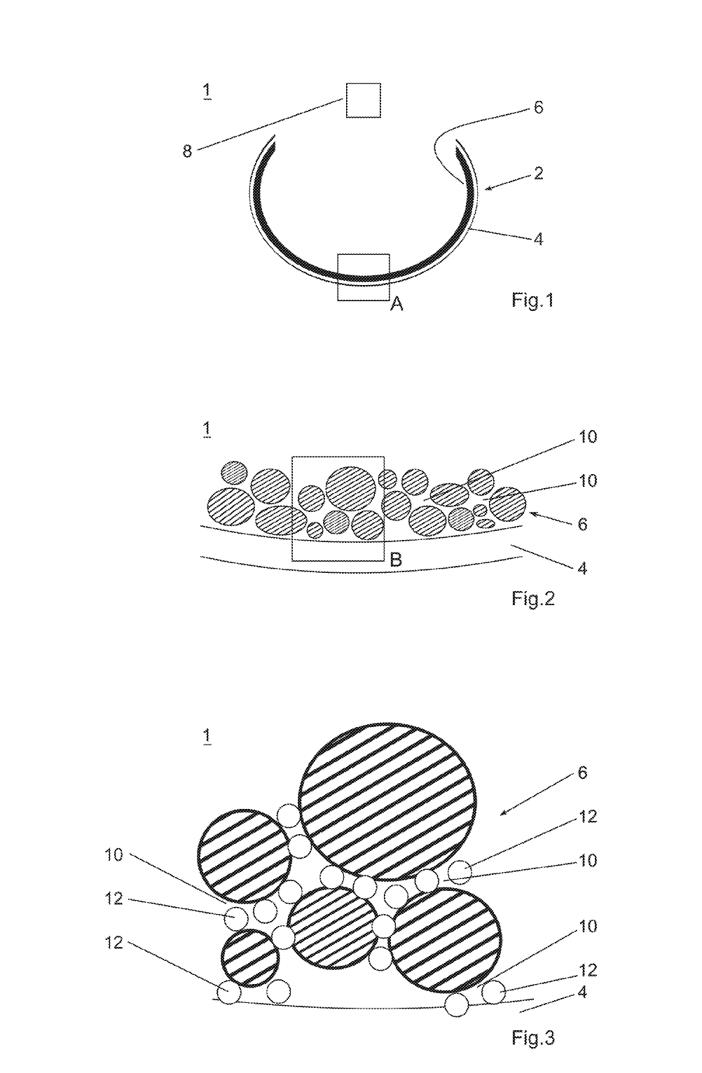

FIG. 1 shows a section through an exemplary embodiment of the apparatus 1 according to the invention, for carrying out the method according to the invention, for producing and for fusing ultra-dense hydrogen.

The apparatus 1, according to the exemplary embodiment, comprises a cavity 2 which is open in places for receiving a gas. The gas here is preferably a hydrogen gas in its molecular form exposed to negative pressure, which is immediately converted into an atomic plasma in the cavity 2.

The cavity 2 is a pore of an open-pore metal foam or ceramic foam 4. The material of the metal foam or ceramic foam 4 should be selected in this case so that even while delivering the highest possible energy during a fusion, the material does not change its alpha lattice state or if this is changed, the alpha lattice state is achieved again.

According to the exemplary embodiment, the pore of the metal foam 4 is at least partially provided with a catalyst coating 6 in the inner side. The catalyst coating 6 here has a granular structure and, according to the exemplary embodiment, contains titanium oxide. The catalyst coating can also be constructed of Fe2O3, Ni, MnO and other materials which can be applied to the metal foam or the ceramic foam as a thin perturbed regular lattice structure having a layer thickness of 10 nm to 4 μm.

Furthermore, the apparatus 1 has an initiating source 8 which can trigger a fusion process in a cavity 2. According to the exemplary embodiment shown, the initiating source 8 is a source of coherent, monochromatic light 8 which can act upon the cavity 2 with electromagnetic radiation. The initiation is accomplished by the thermal radiation of the cavity walls where, due to resonance effects with the walls now mirror-coated by the superfluid hydrogen, preferred wavelengths or frequencies occur with high field intensity. The repulsive potential between protons is very high. The protons are the nuclei of the hydrogen. They undergo their repulsion due to their positive charge (Coulomb repulsion). In ultra-dense hydrogen the nuclei are very tightly packed and therefore very close. The repulsive potential of the nuclei is reduced here by the spherical expansion of the charge and matter cloud of the proton. Furthermore, this repulsion is very severely reduced by other forces such as strong interaction, weak interaction and gravitation and by the shielding of electron states. If ultra-dense hydrogen 12 is formed, the density is very high and the fusion partners, here hydrogen atoms 12, are therefore close to the fusion barrier. Accordingly, a small energy contribution is already sufficient to initiate a fusion. According to the exemplary embodiment, such an ignition of the fusion process is either executed by a coherent monochromatic light source 8 or by the natural black body radiation of the cavity 2, but can also be accomplished by external ionization, for example, by high voltage. Alternatively, a simple spark plug can also be used as initiating source 8 for this purpose.

FIG. 2 shows an enlarged view of the section A from FIG. 1. In particular, the granular structure of the catalyst coating 6 is illustrated here. As a result, a Casimir geometry is created with a plurality of cavities 10 which exert capillary and/or Casimir forces on matter. Thus, corresponding forces can also act on molecular hydrogen introduced into the cavity 2. Furthermore, the “Purcell Effect” is known for such structures, which amplifies electromagnetic processes many times.

FIG. 3 shows a further enlargement of the structure from the exemplary embodiment of the apparatus 1 according to the invention, of section B from FIG. 2. Here, it is illustrated that the granular structure of the catalyst coating 6 splits molecular hydrogen into atomic hydrogen and this then condenses into ultra-dense hydrogen 12 in the cavities 10 or the Casimir geometries 10. This corresponds to a charged state of the apparatus 1.

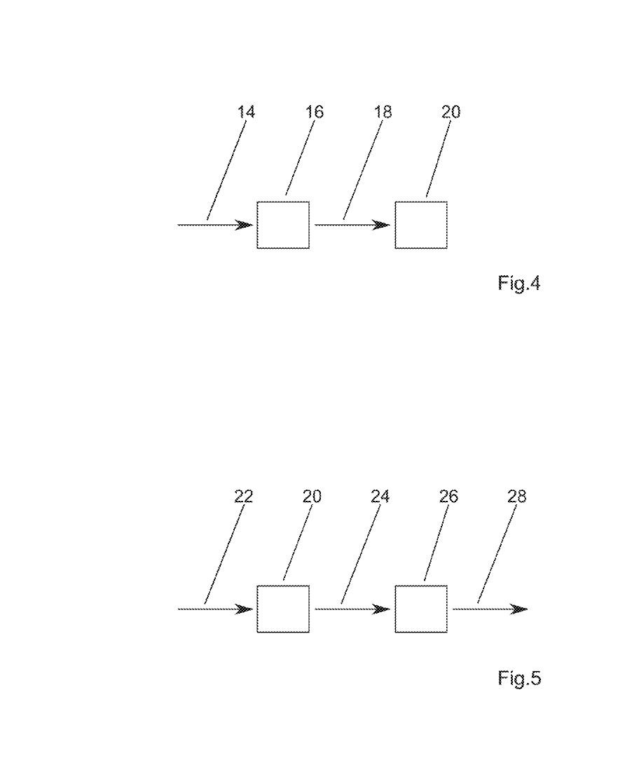

The method according to the invention for generating and fusing ultra-dense hydrogen is explained hereinafter. FIG. 4 shows a schematic view of a charging process of the apparatus 1 according to the method according to the invention. In this case, a gas (reference number 14) is introduced into the cavity 2, which is to be catalyzed and condensed. According to the exemplary embodiment, the gas is molecular hydrogen. Through contact of the hydrogen gas with the catalyst coating 6, the energy required for a plasma formation, and also for a condensate formation, is reduced to such an extent (reference number 16) that this can take place spontaneously at room temperature and even lower temperatures. According to the exemplary embodiment, the condensate is atomic hydrogen which has been catalytically split. The atomic hydrogen then condenses (reference number 20) in the Casimir geometry and becomes embedded in the catalyst coating 6 and is thus present in condensed form as ultra-dense hydrogen 12.

FIG. 5 shows a possible fusion process according to the method according to the invention. An apparatus 1 charged, for example, according to FIG. 4 is assumed. An embedded (reference number 20) condensed ultra-dense hydrogen 12 is excited energetically by an initiating source 8. The condensed hydrogen forms clusters 12. These lie tightly squeezed together and between the heavy catalyst particles 7. The hydrogen protons are very tightly packed—the packing density being obtained from the quantum-mechanical state of the binding electrons in cooperation with the protons. The near field of the catalyst particles 7 assists the condensation. The packing density of the protons lies within the critical density for penetration of the fusion barrier. The energy contribution 22 from the initiating source 8 thus induces a fusion process 24 of the ultra-dense hydrogen. In particular helium, which can volatilize from the catalyst coating 6, is formed by the fusion process 24. In addition to helium, reaction energy 26 in the form of heat is produced. This reaction energy 26 is then guided out from the apparatus 1 via the metal foam/ceramic foam 4 by means of heat conduction and at the surface thereof by means of thermal radiation (reference number 28) or is guided into adjacent regions of the apparatus. The reaction energy 26 can thus be used, for example, for the ignition of fusion in neighboring apparatuses. Furthermore, the reaction energy, in particular reaction heat, can also be converted conventionally into mechanical, chemical or electrical energy and utilized.

Disclosed is a method for generating 18 and for fusing 24 ultra-dense hydrogen 12 in which molecular hydrogen is fed into 14 at least one cavity 2 and catalyzed 16, where a condensation 18 of the molecular hydrogen is initiated on a catalyst 6 of the cavity 2 to form an ultra-dense hydrogen, the ultra-dense hydrogen 12 is exposed to negative pressure or electromagnetic radiation to initiate 22 fusion 24 of the ultra-dense hydrogen 12 in the at least one cavity 2 and the reaction heat 26 is led out from the at least one cavity 2. Furthermore, an apparatus 1 for carrying out the method is disclosed.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

1 Apparatus
2 Cavity
4 Metal foam
6 Catalyst coating
7 Catalyst particle of the catalyst coating
8 Initiating source/laser
10 Cavity/Casimir geometry
12 Embedded ultra-dense hydrogen
14 Introduction of a fluid
16 Catalysis
18 Condensation
20 Embedding
22 Initiating energy
24 Fusion process
26 Reaction energy
28 Guiding out the reaction energy

1-13. (canceled)

14. A method for generating and for fusing ultra-dense hydrogen, in which molecular hydrogen is led into at least one cavity and catalyzed, comprising the following steps:
initiating condensation of the molecular hydrogen at a catalyst of the cavity to an ultra-dense hydrogen,
initiating fusion of the ultra-dense hydrogen in the at least one cavity, and
guiding reaction heat out from the at least one cavity.

15. The method according to claim 14, wherein molecular hydrogen is bound to the ultra-dense hydrogen after the condensing.

16. The method according to claim 14, wherein the fusion is initiated electrically, electromagnetically or mechanically.

17. The method according to claim 14, wherein the reaction heat guided out from the at least one cavity is used for further initiation of fusion.

18. The method according to claim 14, wherein the reaction heat guided out from the at least one cavity is converted into mechanical, electrical or chemical energy.

19. An apparatus for carrying out a method for generating and for fusing ultra-dense hydrogen, in which molecular hydrogen is led into at least one cavity and catalyzed, comprising the steps of initiating condensation of the molecular hydrogen at a catalyst of the cavity to an ultra-dense hydrogen, initiating fusion of the ultra-dense hydrogen in the at least one cavity, and guiding reaction heat out from the at least one cavity, the apparatus comprising
at least one cavity for receiving molecular hydrogen,
a catalyst for catalyzing the molecular hydrogen,
an initiating source for initiating a fusion,
wherein the at least one cavity is at least one pore or vacancy of a metal or ceramic foam which is surrounded at its surfaces by the catalyst, at least in certain areas, and has an at least partial permeability for electromagnetic waves.

20. The apparatus according to claim 19, wherein the catalyst has the form of a catalyst coating.

21. The apparatus according to claim 19, wherein the catalyst coating has a granular structure.

22. The apparatus according to claim 19, wherein the molecular hydrogen can be condensed on the catalyst coating to ultra-dense hydrogen.

23. The apparatus according to claim 19, wherein ultra-dense hydrogen can be bound in the catalyst coating.

24. The apparatus according to claim 19, wherein the catalyst coating comprises a titanium oxide.

25. The apparatus according to claim 19, wherein the surface of the at least one cavity can be coated by the condensed ultra-dense hydrogen.

26. The apparatus according to claim 19, wherein further metals are added to the catalyst to form ultra-dense hydrogen at high pressures.
